(19) United States
(12) Patent Application Publication
(10) Pub. No.: US 2018/0283371 A1
(43) Pub. Date: Oct. 4, 2018

(54) DISTRIBUTOR DEVICE AND PRESSURE LIMITER, IN PARTICULAR FOR A HYDRAULIC ASSISTANCE DEVICE ON A VEHICLE AND VEHICLE PROVIDED WITH SAME

(71) Applicant: Poclain Hydraulics Industrie, Verberie (FR)

(72) Inventors: Ante BOZIC, Verberie (FR); Bastien CLAPIT, Verberie (FR); Julien LAMBEY, Verberie (FR)

(21) Appl. No.: 15/557,792

(22) PCT Filed: Nov. 12, 2015
(86) PCT No.: PCT/EP2015/076491

§ 371 Date: Dec. 28, 2017

(30) Foreign Application Priority Data
Mar. 13, 2015 (FR) 1500495
Jun. 10, 2015 (FR) 1555295

(51) Int. Cl. F04B 49/22; B60K 17/356; F04B 1/04; F04B 9/109; B60K 17/10; F16H 39/02; F16H 61/4017; F16K 17/04

(52) U.S. Cl. CPC F04B 49/22; B60K 17/356; F04B 1/04; F16K 17/04; B60K 17/10; F16H 39/02; F16H 61/4017; F04B 9/109

(57) ABSTRACT

The invention relates to a distributor device and pressure limiter suitable for being installed in a system comprising a first supply line (11) and a second supply line (12) able to contain pressurised oil, and comprising an evacuation and/or booster line (10), characterised in that the device comprises means forming a pressure selector (72) suitable for connecting the lower-pressure supply line to the evacuation and/or booster line and means (71) forming two valves respectively associated with one of the two supply lines (11, 12) and suitable for opening in the event of an overpressure greater than a predetermined threshold on the associated supply line in order to discharge the corresponding overpressure to the evacuation and/or booster line (10) or to the other supply line, the two relief valves comprising a common plug (162) which engages with a single seat (155).

### GENERAL TECHNICAL FIELD

The invention relates to managing excess pressures in hydraulic circuits, and more particularly to devices of the “pressure limiter” or “pressure-relief valve” type.

The invention applies in particular to hydraulic assistance circuits for a vehicle.

The invention thus belongs to the field of vehicle hydraulic assistance and in particular the engagement and the disengagement of this assistance.

Temporary hydraulic assistance is carried out using hydraulic machines which may supply torque to wheels not mechanically motorized. These machines transform the hydraulic energy of pressurized oil into mechanical energy, or the reverse.

Two phases of use are defined: the assistance phase which allows an increase in power/torque, and a freewheel phase. Between these two phases are two transient phases allowing engaging or disengaging hydraulic assistance.

To activate such assistance, the hydraulic circuits are pressurized thanks to a booster pump. This pressure serves in particular for engaging the motors.

### PRIOR ART

FIG. 1 shows a hydraulic schematic of the prior art.

In a vehicle Ve, a first hydraulic machine M1 is mounted on a first axle, for example the front axle and a second hydraulic machine M2 is mounted on a second axle, for example the rear axle. What is meant by machines is that they may function as motors or as pumps.

The configuration shown corresponds to a “bicycle chain” (document FR 2 996 176), meaning that during the main use, the first machine M1 acts as a pump for the second machine M2, which acts as a motor.

The vehicle generally comprises a heat engine M which drives the first hydraulic machine M1.

To this end, the discharge of the first machine M1 is connected to the intake of the second machine M2 by a line 11 called a high pressure line and the discharge of the second machine M2 is connected to the intake of the first machine M1 by a line 12 called a low pressure line.

The terms high and low pressure correspond to use when driving forward with torque addition (“main use”).

Consequently, as pressure may be reversed, the terms first line 11 and second line 12 are preferred.

An electric pump unit P, including a booster pump P1 in particular, and an electric motor P2, is provided for boosting lines 11, 12.

By way of an example, the booster pump P1 may also be driven by other elements, such as an axle or a heat engine M.

A pressure limiter 20 is located so that it by-passes the pump P1 for protecting it from possible excess pressure.

The booster pump P1 feeds, through a booster line 10, the first and second lines 11, 12 via two check valves B11, B12 which prevent the oil from being discharged toward the pump P1 when the boost pressure is less than the operating pressures.

The oil comes from a drainage line 13 which is connected to one or more reservoirs R.

The first and the second line 11, 12 operate in a closed circuit and may be subject to excess pressures which may damage the machines M1, M2 or the seals present in the circuit.

By way of an example, the pressures are on the order of 400 bars in one line and a few tens of bars in the other line, at the very least at a boost pressure.

In a classical way, two pressure limiters A11, A12 protect the first and second lines 11, 12 from excess pressure by discharging oil into the booster line 10.

The hydraulic circuit also has a vacuum valve V situated on a vacuum line L.

The vacuum line connects the first or the second line 11, 12 (a selector valve may if necessary be placed between the lines 11 and 12) to the drainage line 13 which leads to the reservoir R.

The valve V is a 2/2 way valve, comprising an inlet and an outlet. The inlet is connected to the line 12 and the outlet to the drainage line 13. The valve V has a passing state and a blocking state.

The change toward a blocking state occurs using a solenoid spool V1, which is controlled electronically. This change of state causes a first transient phase by allowing the effective activation of the hydraulic assistance because the high and low pressure lines 11, 12 are then no longer connected to the reservoir R and may increase in pressure. This pressure increase allows the couplers E1 and E2, which link the components of the hydraulic machines M1 and M2 to the output shafts of said machines, to be activated, so as to make them active in the vehicle, in other words to engage the system. These couplers may be of the disk or claw clutch type, for example of the same type as in the prior art gearbox. They may also constitute the coupling of radial piston motors which disengage from their cam by retraction of the pistons.

Conversely, a spring V2 holds in the rest position the valve V, in a passing state. As soon as the spool V1 is no longer controlled, the valve V resumes a passing position and causes a second transient phase, wherein the pressure in the low pressure line drops, thus disengaging the hydraulic assistance.

Also known is a simplified alternative of the embodiment shown in FIG. 1 with a valve which, in the rest position, opens the vacuum line L and blocks the booster line 10, and vice versa in the controlled position.

Thus, according to the prior art, for the two aforementioned transient steps, it is necessary to intervene electronically on several elements, and in particular the valves V and the booster pump, which imposes structural and electrical network constraints.

As indicated previously, pressure limiting means A11, A12 are provided, designed to protect the first and second lines 11, 12 from excess pressures because the lines 11, 12 operate in a closed circuit and may otherwise be subject to excess pressure likely to damage the machines M1, M2 or the seals present in the circuit.

FIG. 2 shows a first variant of the prior art: a first pressure limiter 21 is disposed between the first line 11 and the booster line 10, and a second pressure limiter 22 is disposed between the second line 12 and the booster line 10.

Each limiter 21, 22 may be set to the desired value.

This solution uses two protection members (the pressure limiters 21, 22).

FIG. 3 shows a second variant of the prior art: two pressure limiters 23, 24 are disposed between the first and second lines 11, 12. One line always having lower pressure, it may tolerate the excess pressure present in the other.

This solution also uses two protection members (the pressure limiters 23, 24). Also found again in FIG. 3 are two check valves B11, B12 which are used for boosting.

FIG. 4 shows a third variant of the prior art: a high-pressure selector valve 25 selects the line with the higher pressure between the first and the second line 11, 12 and sends it to the booster line 10 via a pressure limiter 26. In this manner, one pressure limiter is eliminated, but a circuit selector valve 25 must be added.

This solution also uses two protection members. Also found again in FIG. 4 are two check valves B11, B12 which are used for boosting.

To optimize the available space and reduce the costs of manufacture, simpler members carrying out the same functions are sought.

An attempted solution is proposed in document US 2005/0097887 as illustrated in the appended FIG. 5.

This solution consists of grouping all the functions forming the selector valve and pressure limiter into a common cartridge.

More precisely, in the appended FIG. 5 the body of the cartridge designated 30 defines three passages 32, 34 and 36 designed to communicate respectively with the aforementioned lines 11, 12, and 10, a selector valve in the form of a cage movable in translation in the body 30 under the influence of the pressure difference between the passages 32 and 34 is designated 40, and the plugs of the two pressure relief valves associated with an interleaved spring 54 and mounted in translation inside the selector valve 40 are designated 50 and 52. When the pressure applied to one of the passages 32, 34 exceeds a threshold defined by the setting of the spring 54, the corresponding plug 50 or 52 moves away from its seat and thus allows the pressure to be limited.

The applicant has identified in particular that, in the device of the type described in document US 2005/0097887 and illustrated in the appended FIG. 5, there exists a risk of blocking the plugs of the pressure relief valves when, due to guidance failure, the plugs are placed in an oblique position with respect to their theoretical direction of translation.

The device described in document US 2005/0097887 has not undergone significant industrial development. This seems to be due to its complexity of design, of assembly and of operation.

### PRESENTATION OF THE INVENTION

In the aforementioned context, the first objective of the present invention is to propose means which improve the state of the art, particularly by proposing simple design means which improve performance.

The objective is attained according to the invention thanks to a distributor and pressure relief device suitable to be installed in a system comprising a first feed line and a second feed line which may comprise pressurized oil and comprising a discharge and/or booster line, characterized in that the device comprises means forming a pressure selector valve suitable for connecting the lower pressure feed line to the discharge and/or booster line and means forming two valves associated respectively with one of the two feed lines and suitable for opening in the event of excess pressure above a predetermined threshold in the associated feed line so as to discharge the corresponding excess pressure toward the discharge and/or booster line or the other feed line, the two valves comprising a common plug which cooperates with a single seat.

Henceforth, pressure limitation occurs according to the invention by means of a single device, which improves the compactness of the system as well as its cost of manufacture.

According to another advantageous feature of the invention, the plug has at least two surfaces situated on either side of the associated seat and subjected respectively to the pressures coming from the two feed lines.

According to another advantageous feature of the invention, the device comprises confinement means suitable for applying pressure coming from a feed line to a limited localized zone of the plug.

According to another advantageous feature of the invention, the device comprises two translation guides for the plug, separated along the direction of translation thereof, by a distance equal to at least one times the diameter of the plug resting on the associated seat, preferably by a distance equal to at least two times this diameter and very advantageously equal to at least five times this diameter.

According to another advantageous feature of the invention, the device comprises a first translation guide for the plug formed by the cooperation defined between the plug and its associated seat and at least a second guide formed by an end of a plug stem guided on the body, for example a widened surface subjected to the pressure of a feed line.

According to another advantageous feature of the invention, the two pressure relief valves comprise a common support stem which works in tension or in compression under the biasing of at least one spring defining a setting which corresponds to said predetermined threshold.

The invention also relates to assistance systems and to vehicles equipped with a pressure relief device conforming to the invention.

### PRESENTATION OF THE FIGURES

Other features, aims and advantages of the invention will be revealed from the description that follows, which is purely illustrative and not limiting, and which must be read with reference to the appended drawings, wherein:

FIG. 1 shows a hydraulic circuit and particularly a booster circuit known from the prior art,

FIGS. 2 to 4 show 3 hydraulic circuit variants known from the prior art,

FIG. 5 shows a distributor and pressure relief device known from the prior art, more precisely from document US 2005/0097887,

FIG. 6 shows an embodiment of a hydraulic assistance circuit conforming to the invention,

FIG. 7 shows a valve conforming to the invention forming a distributor and pressure relief device allowing the implementation of the circuit of FIG. 6,

FIGS. 8 to 11 show a variant embodiment of such a valve conforming to the present invention forming a distributor and pressure relief device; more precisely FIG. 8 presents in an axial section view the different parts composing this valve, while FIGS. 9 to 11 present the same valve in 3 operating states depending on the pressures prevailing in the feed lines,

FIG. 12 shows a schematic of a portion of a hydraulic machine,

FIG. 13 presents a variant embodiment according to which the device forming the selector valve and the pressure limiter is integrated into a machined support body equipped with two closure caps.

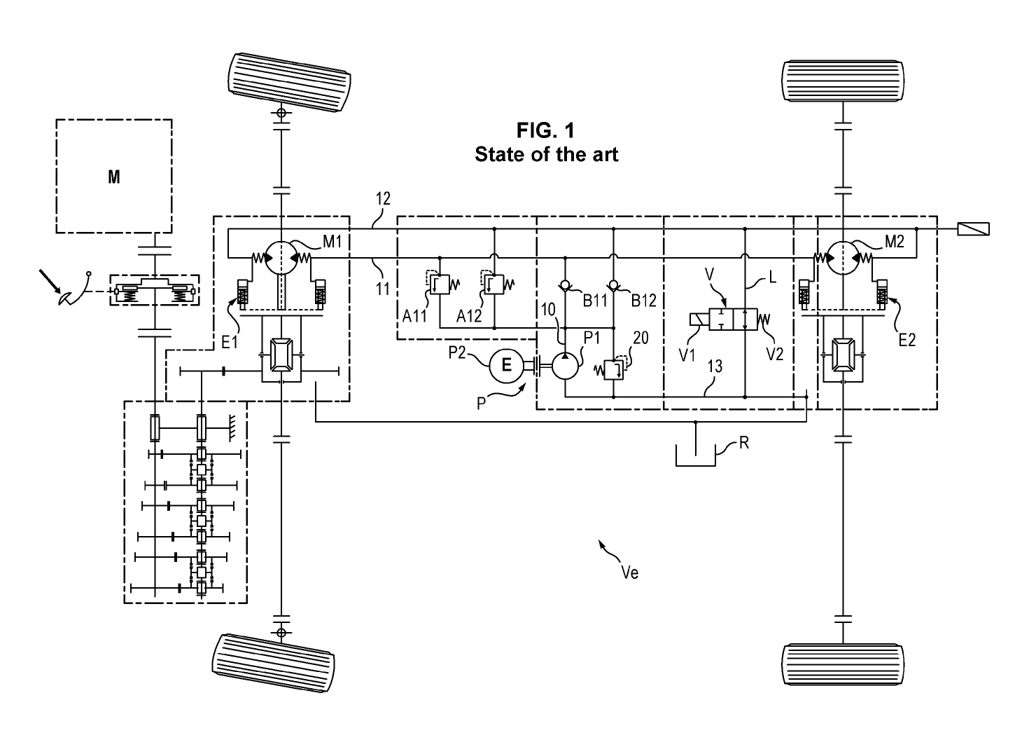

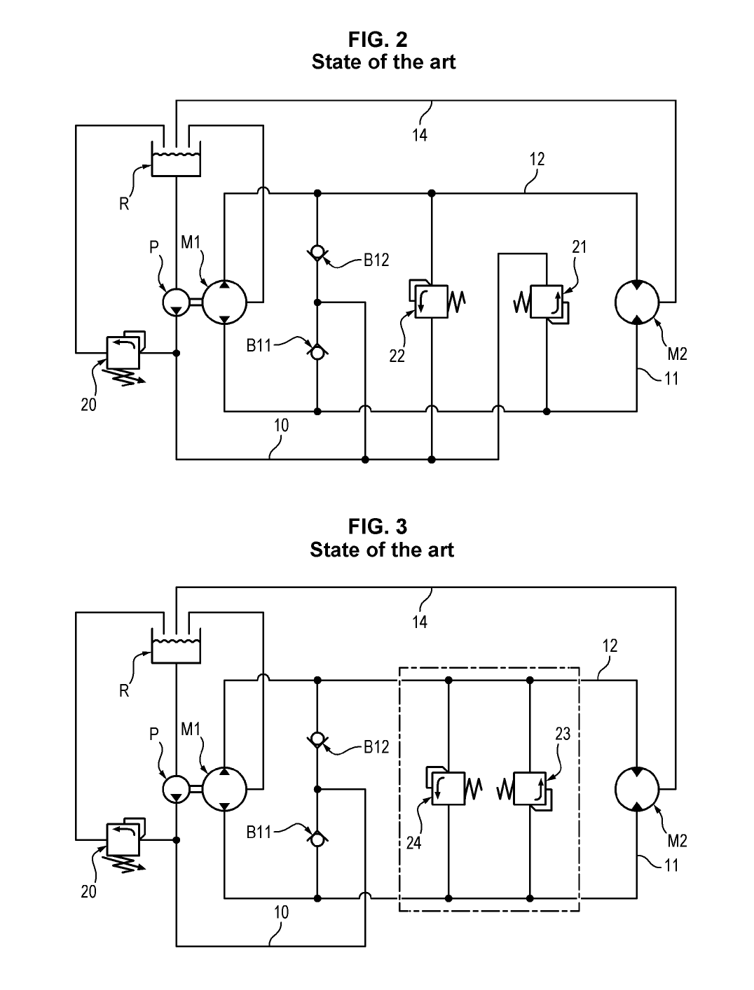

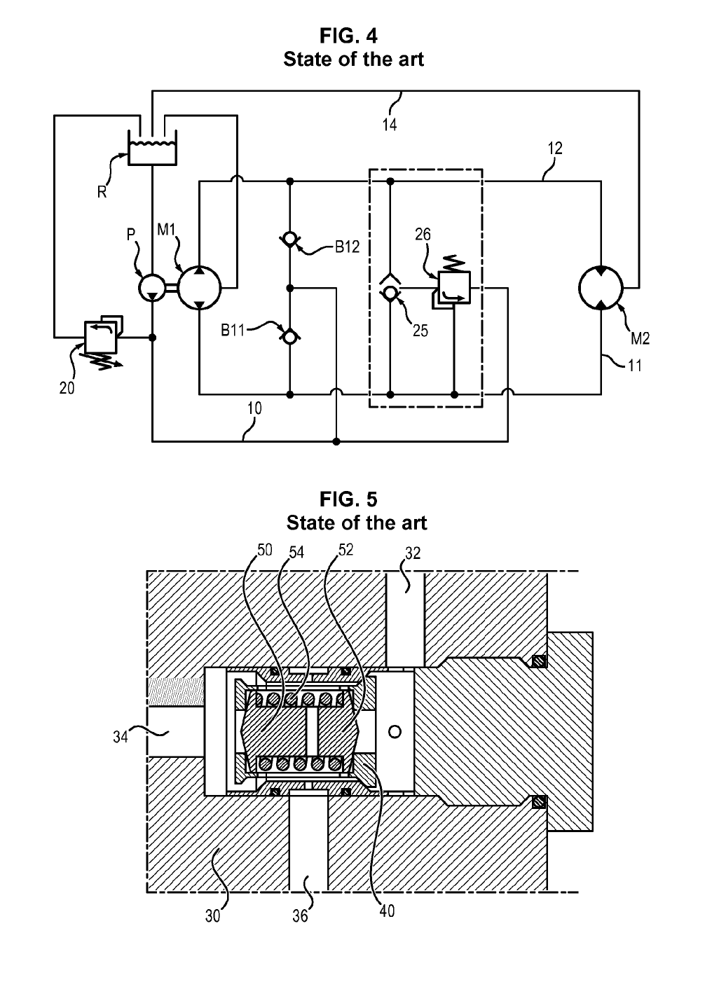

### DETAILED DESCRIPTION

The preferred embodiments of the invention will now be described.

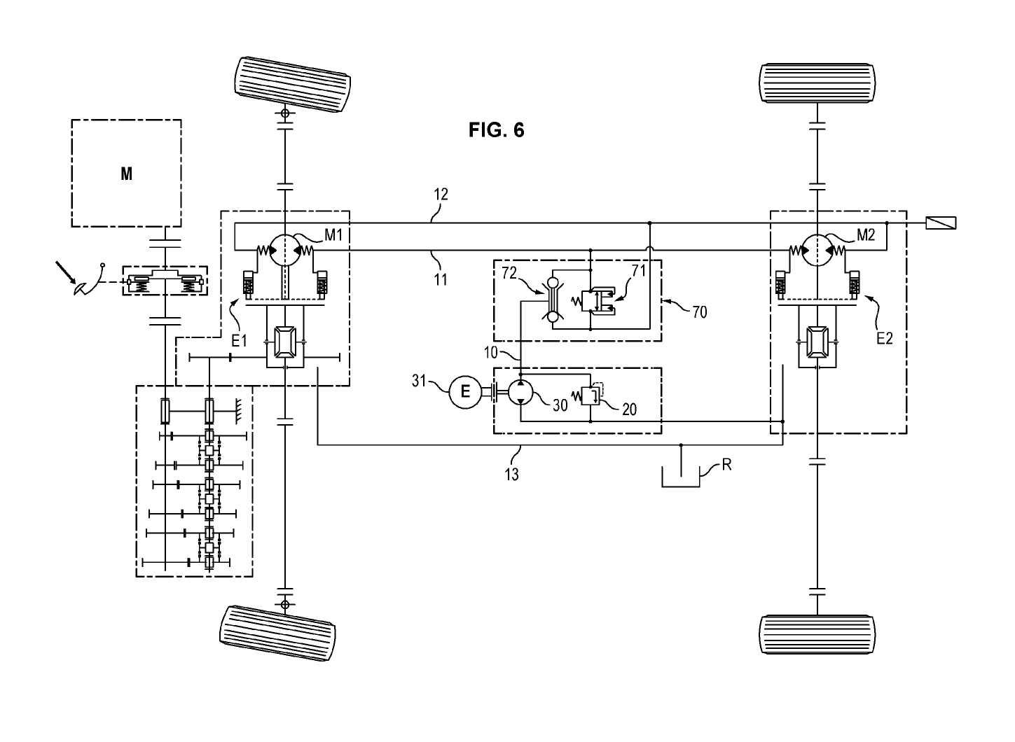

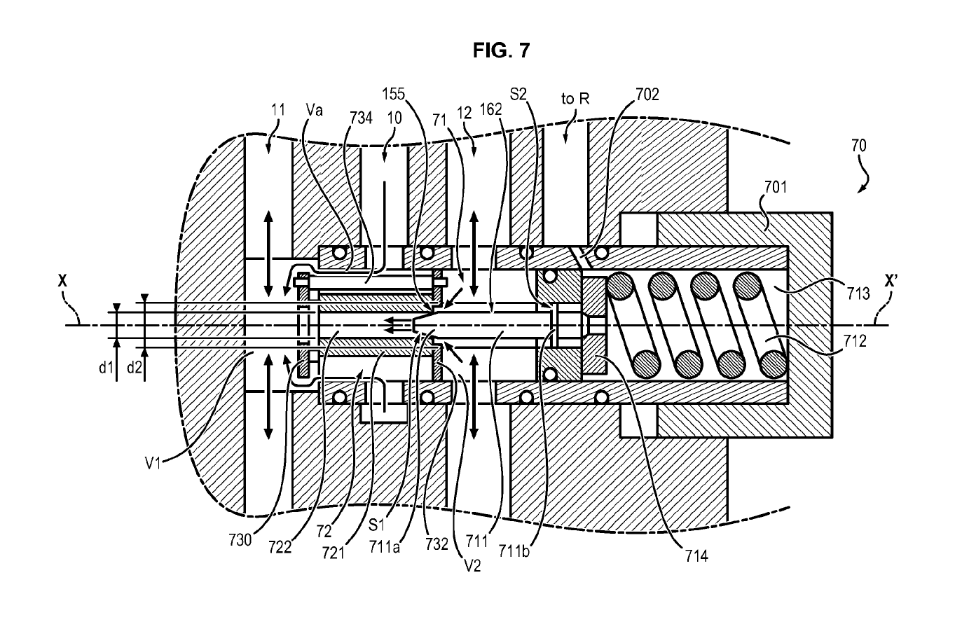

The appended FIG. 6 shows the use in a hydraulic assistance circuit, of the distributor and pressure relief device 70 conforming to the invention shown in FIG. 7.

The distributor and pressure relief device 70 shown in FIG. 7 comprises, in a common cartridge casing, on the one hand a pressure selector valve 72 and on the other hand two pressure relief valves grouped into a common assembly 71. The selector valve 72 and the pressure limiting assembly 71 will be described in more detail hereafter.

The circuit illustrated in FIG. 6 comprises two hydraulic machines M1, M2 in “bicycle chain” operation, as mentioned in the introduction.

These machines M1, M2 are linked together by a first line 11 and a second line 12 which feed the machines with oil.

Depending on the operating modes, the direction of circulation of the oil and the pressure in these lines 11, 12 may change.

For example, when the equipped vehicle is driven forward and in “torque addition” mode, the first machine M1 acts as a pump and the second machine M2 acts as a motor. Considering that the first line 11 connects the discharge of the first machine M1 to the intake of the second machine M2 and that the second line 12 connects the discharge of the second machine M2 to the intake of the first machine M1, in this case there will be high pressure in the first line 11 and low pressure in the second line 12 and a direction of circulation of the oil from the first machine M1 toward the second M2 in line 11.

What is meant by high pressure is pressures which may be greater than a few hundred bars, for example 400 bars, and low pressures are pressures of a few tens of bars, for example 3 or 30 bars. The low pressure is differentiated from the pressure of the unpressurized oil reservoirs, represented for example by the casings of the machines M1 and M2, and the unpressurized reservoir R, substantially connected to atmospheric pressure. The pressure at low pressure differing from atmospheric pressure is, in known fashion, necessary for proper operation of a closed-circuit transmission.

In operation, a closed loop transmission has a HP line and a LP line. If no torque is produced by the machines, the two lines are at LP pressure, which is a minimal pressure for the closed circuit during operation.

Driving in reverse, the direction of circulation of the oil is reversed and the high pressure is then found in the second line 12 and the low pressure in the first line 11.

Similarly, when the vehicle is under “restraint,” while going downhill for example, the pressure may also change in lines 11, 12.

These machines M1, M2 are clutched, i.e. engaged, thanks to couplers E1, E2 fed hydraulically by the first and second lines 11, 12. The couplers E1, E2 shown connect the engine blocks of the hydraulic machines to the shafts which pass through them, and make the machines active.

A booster circuit is provided for feeding the lines 11, 12 with oil so as to allow the engagement of the machine M1, M2, and also to compensate for oil leaks. This circuit allows the lines to which it is connected to be held at the low pressure minimal pressure, called the boost pressure. The lines 11 and 12 are therefore always at the boost pressure when the system is activated.

For this purpose, a booster pump 30, which will be called the “pump 30,” is provided. It is connected to a reservoir R by a drainage line 13 and may feed the first and second lines 11, 12 via a booster line 10 in particular.

The booster pump 30 may deliver oil under a pressure of a few tens of bars, substantially equivalent to the low pressure.

The pressurization of the HP and LP lines of the closed loop by the booster circuit allows the activation of the hydraulic machines M1 and M2 via the actuation of the couplers E1 and E2. Conversely, the removal of oil from the closed loop induces a drop of pressure in the lines, which releases the couplers E1 and E2 and frees the machines M1 and M2, which makes them inactive.

According to a preferred feature of the invention, the pump 30 is configured to be able to aspirate oil from the booster line 10 and in particular to discharge it toward the reservoir R via the drainage line 13.

The vacuum is thus accomplished by reversing the direction of operation of the pump 31 and there is no longer a need for a vacuum valve nor a specific vacuum line.

For this purpose, the first and second lines 11, 12 no longer each comprise an autonomous check valve B11, B12 as before. In fact, aspiration in the booster line 10 would lead to the locking of these check valves, which would prevent the oil from returning to the booster line 10.

When hydraulic assistance is required, the device operates conventionally, with activation of the pump 30 to inject oil into the booster line 10, which will then pressurize the first and second lines 11, 12 and if necessary the couplers E1, E2 to engage the machines M1, M2.

On the other hand, when hydraulic assistance is no longer required, the pump 30 reverses its direction of operation, i.e. instead of collecting oil in the reservoir R to inject it into the booster line 10, it collects oil in the first and/or second lines 11, 12 via the booster line 10 and sends it to the reservoir R. Thus, the first and second lines 11, 12 are decompressed and the disengagement of the machines M1, M2 is accomplished thanks to aspiration by the pump 30 of the necessary volume of oil.

The disengagement is accomplished rapidly thanks to the aspiration of the pump 30 which is considered to be more effective than a mere vacuum through opening a vacuum valve.

Depending on the architectures, only the line corresponding to that at low pressure when driving forward and with torque addition, among the two lines 11, 12, is connected to the booster line 10.

More precisely, the vacuum produces cavitations in the cylinders of the hydraulic machines M1, M2. The decompression of the lower pressure line creates dead volumes under the pistons and, due to the rotation of the machines M1, M2, the dead spaces are filled by the high pressure line, which allows the vacuum of the of the higher pressure line as well. When the machines M1, M2 turn, one of them will collect oil in the higher pressure line, toward the low pressure line, where it will be aspirated through the valve. Furthermore, the low pressure line being emptied, the pressure will therefore decrease in both lines 11 and 12 at the same time. Thus the aforementioned dispositions allow, on this particular circuit, reducing the pressure in both lines, even if only one of them is connected directly to the pump. The expression “directly connected” must be understood to signify “without passing through another hydraulic machine” or “connected by an open valve to the line going in the direction of the booster pump.”

This is a voluntary cavitation method, caused in particular by the aspiration of the pump 30, which accelerates the vacuum.

Thus this is a transition from a passive vacuum (stoppage of control of the pump and of the vacuum valve) to an active vacuum, while eliminating a valve (the vacuum valve) and materially eliminating a line (the vacuum line present in the prior art).

Preferably, the pump 30 is fed by an electric unit 31, forming an electric pump unit EPU. A pressure limiter 20 is disposed in parallel with the pump 30, in a conventional manner.

The reversal of the direction of rotation of the electric motor 31 causes the pump 30 to operate in reverse direction. The speed and the duration of activation are functions of the volume of oil to be aspirated and of the features of the device, such as the cylinder displacement.

It is thus necessary to have an EPU 30, 31 available which may operate in both directions of rotation.

According to the invention the booster line 10 is connected to the first and second lines 11, 12, by a low pressure selector valve 72 (an “inverse shuttle valve”). This allows the lower pressure line 11 or 12 to always be boosted (when the vehicle is in reverse or under restraint, the pressures in lines 11, 12 may be reversed).

The selector valve 72 leaves the lower pressure line constantly open and therefore connects this lower pressure line with the booster line 10.

The pressure limiters, grouped in the form of a common assembly designated 71 in FIG. 6 are again found in parallel with the selector valve 72. The assembly 71 will be described in more detail hereafter. It protects the first and second lines 11, 12 from possible excess pressure.

The low pressure selector valve 72 is typically constituted from two check valves back to back, each comprising a sealing element, a ball for example, or a valve with a form suitable for the flow rates and pressures of the system. The sealing element, for example and without limitation a ball or an equivalent means, is housed on a respective seat to block the passage of oil.

The balls or the aforementioned equivalent means are held at a minimum distance from one another by a rigid means, for example a stem, so that one of the two valves is constantly open. The balls or the aforementioned equivalent means, may also be secured to the rigid means.

As soon as pressure is higher on one side, the aforementioned sealing element, a ball for example, or the aforementioned equivalent means, is pressed against the associated seat and blocks communication between the feed line 11, 12 and the booster line 10, thus freeing the opening on the other side between the other feed line 12, 11 and the booster line 10.

In addition, thanks to the rigid means interposed between the two sealing means, plugs or balls, which holds one of the two valves open, there is no risk of blocking the selector valve 72 when the pump 30 is aspirating in the booster line 10 and creates a pressure drop.

FIGS. 6 and 7 show a valve 70 comprising both a pressure limiter 71 and a low pressure selector valve 72. In this valve 70, the limiter 71 is a dual limiter situated between the first and second lines 11, 12.

Excess pressure in one of the two lines 11, 12, will be discharged by spilling oil into the other line 12, 11.

The valve 70 comprises a cartridge 701 in which are found a pin 711 and a tappet 721. These latter two may slide in relative translation along a longitudinal axis X-X′. More precisely, the tappet 721 is preferably fixed in the body of the cartridge 701, while the pin is movable in translation in the body of the cartridge 701.

The tappet 721 delimits the volume of the cartridge 701 into a first volume V1 fed by the first line 11 and into a second volume V2 fed by the second line 12. The two volumes V1, V2 are not completely independent and may communicate fluidically with one another through an internal channel 722 which is included in the tappet 721.

In addition, the tappet 721 defines, with the cartridge 701, an annular volume Va between said tappet 721 and the cartridge 701. This annular volume Va is always in communication with the booster line 10 and is alternatively in communication with the first or the second volume V1, V2. Thus, even during when the booster pump 10 is aspirating, there is no risk of blockage.

The pin 711 comprises a first end 711a which is suitable for blocking the inner channel 722 in a rest position and for opening it into an operating position. These two positions are obtained by translation of the pin 711 along X-X′. A second end 711b of said pin 711 is in contact with a spring 712 which holds the pin 711 in the rest position. In this rest position, the tapered end 711a of the pin 711 rests against the end of the inner channel 722 of the cylinder 721 which forms a seat 155.

When the inner channel 722 is blocked, the position of the tappet 721 depends on the pressures exerted in the first and second volumes V1, V2:
When the pressure in the first volume V1 is greater than that of the second volume V2, the tappet 721 places in communication the drainage line 10 with the second volume V2 and therefore the second line 12,
When the pressure in the second volume V2 is greater than that of the volume V1, the tappet 721 places in communication the drainage line 10 with the first volume V1 and therefore the first line 11. Thus, the tappet 721, when it is blocked, has the function of a low pressure selector valve 72.

The pin 711 further comprises a first surface S1 leading into the first volume V1 on which a force is exerted originating from the pressure of the first volume V1. In practice, this first surface S1 corresponding to the surface blocking the inner channel 722. The pin similarly comprises a second surface S2 leading into the second volume V2 and on which a force is exerted originating from the pressure of the second volume V2. In practice, this surface S2 is situated between the volume V2 and a housing 713 of the spring 712.

The first surface S1 is preferably a frusto-conical surface formed on the first end of the pin 71 and engaged in the inner channel 722 of the tappet 721. The second surface S2 is preferably formed from an annular collar protruding from the periphery of the pin 711 in the vicinity of the second end 711b thereof.

Both forces due to the pressure of the fluid present in the lines 11 and 12, are exerted in the same direction and tend to place the pin 711 in the operating position, i.e. to compress the spring 712 and to open the inner channel 722, by moving the pin 711 away from the tappet 722.

Thus, when the force exerted on the pin 711 by the pressure of the fluid is greater than the force of the spring 712, the inner channel 722 opens and the two volumes V1, V2 communicate with one another to allow the excess pressure to be discharged from a line 11, 12 to the other 12, 11. The pin 711 and the spring 712 form the pressure limiter 71 which combines two pressure limiters.

It is therefore understood that the device illustrated in FIG. 7 comprises means forming two valves associated respectively with one of the two lines 11 and 12 and suitable for opening in the event of excess pressure above a predetermined threshold in the associated line so as to discharge the corresponding excess pressure toward the discharge and/or booster line or toward the other feed line 12 or 11, the two valves comprising a common plug 711 which cooperates with a single seat 722.

It is possible to obtain different pressure settings between the pressure threshold existing in the first volume V1 which causes the opening of the relief valve, and the pressure threshold existing in the second volume V2, which causes the opening of the relief valve, by selecting suitable surfaces S1, S2. In practice, given the pressures involved, (for example 400 bars in one line against 30 bars in the other), only one of the two volumes V1, V2 exerts significant force against the spring 713.

This valve 70 which integrates a limiter 71 which acts with a single spring 713 and which integrates a low pressure selector valve 72 allows better compactness of the device than the known devices of the prior art.

According to the embodiment illustrated in FIG. 7, the selector valve tappet is formed from a cylinder 721 fixed in the body of the cartridge. The selector valve proper consists of an assembly which comprises two plugs 730 and 732 connected by an interposed rigid element, for example at least one stem 734 parallel to the axis X-X′. The length of the interposed rigid element, formed for example by at least one stem 734, is greater than the length of the cylinder 721. The two plugs 730 and 732 are each preferably formed from a washer positioned facing one of the ends of the cylinder 721. The outer diameter of the washers 730 and 732 is equal to the inner diameter of the chamber of the body which accommodates the selector valve. The inner diameter of the washers in less than the outer diameter of the cylinder 721. The plug washer 730 is subjected to the pressure applied by the line 11. The plug washer 732 is subjected to the pressure applied by the line 12.

Thus, when the pressure in the line 11 is less than the pressure in the line 12, the washer 732 is pressed against the cylinder 721, while the washer 730 is separated from the cylinder 721. The washer 732 closes the passage communicating with the line 12 as may be seen in FIG. 7 while the washer 730 being separated from the cylinder 721, allows a connection between the line 11 and the booster line 10.

Conversely, when the pressure in the line 11 is greater than the pressure in the line 12, the washer 730 is pressed against the cylinder 721 while the washer 732 is separated from the cylinder 721. The washer 730 closes the passage communicating with the line 11 while the washer 732 being separated from the cylinder 721 allows a connection between the line 12 and the booster line 10.

As may be seen upon examining the appended FIG. 7, the plug 711 has at least two surfaces S1 and S2 situated on either side of the associated seat 155 formed on the cylinder 721 and subjected respectively to the pressures coming from the two feed lines 11 and 12.

Moreover, the device comprises confinement means suitable for applying the pressure coming from the feed line 12 to a limited localized zone of the plug 711, at the second end thereof forming the second biasing surface S2. More precisely here, as may be seen in FIG. 7, the collar which defines the second surface S2 is placed in a housing of complementary diameter. Thus the pressure that prevails in the feed line 12 applies only at the face of this collar directed toward the seat 155.

The device illustrated in FIG. 7 also comprises two translation guides for the plug, separated along the longitudinal direction of translation X-X′ thereof, by a distance equal to at least one times the diameter of the plug 711 resting on the associated seat 155, preferably a distance equal to at least two times this diameter and very advantageously, as illustrated in FIG. 7, equal to at least five times this diameter.

Still more precisely, as illustrated in FIG. 7, the device comprises a first translation guide for the plug 711 formed by the cooperation defined between the tapered end 711a of the plug 711 and its associated seat 155 and at least a second guide formed by the second end 711b of the plug stem 711 guided on the body at the aforementioned collar defining the biasing surface S2, i.e. at the widened surface subjected to the pressure of the feed line 12.

The presence of such dual guide allows the reliability of the device to be improved with respect to the dispositions proposed in the prior document US 2005/0097887. In fact, the presence of the two guides separated by a distance at least equal to the diameter of the seat 155 and preferably greater than five times this diameter, allows avoiding having the plug placing itself in an oblique position with respect to the desired translation direction X-X′.

Moreover, the fact of forming the two plugs of pressure relief valve associated respectively with the two lines 11 and 12 on a common means 711, by disposing the two biasing surfaces respectively on either side of the seat 155, allows a considerable guide distance (typically greater than 5 times the diameter of the seat 155) to be retained, without however imposing a prohibitive longitudinal space requirement. It is understood in fact that, if the device integrates two separate plugs respectively for each pressure relief valve, the cumulative longitudinal space requirement of the two plugs would at least be equal to 10 times the diameter of the seat 155, if it is desired to ensure guidance of each plug with two guide means separated by 5 times the diameter of the seat 155.

According to the appended FIG. 7, the spring 712 is placed in a chamber 713 which communicates with the reservoir R by means of a through passage 702. A disk 714 is interposed between the end of the pin 711 and the spring 712. The communication defined between the chamber 713 and the reservoir R allows excess pressure in the chamber 713 to be avoided when the relief valve opens and the collar consequently moves in its complementary housing forming a piston effect.

Moreover, the passage 702 may serve as a damper for the movement of the plug valve if its cross-section is calibrated to slow the transfer of oil.

It is understood that the stem which forms the pin 711 operates in compression under the biasing of the spring 712.

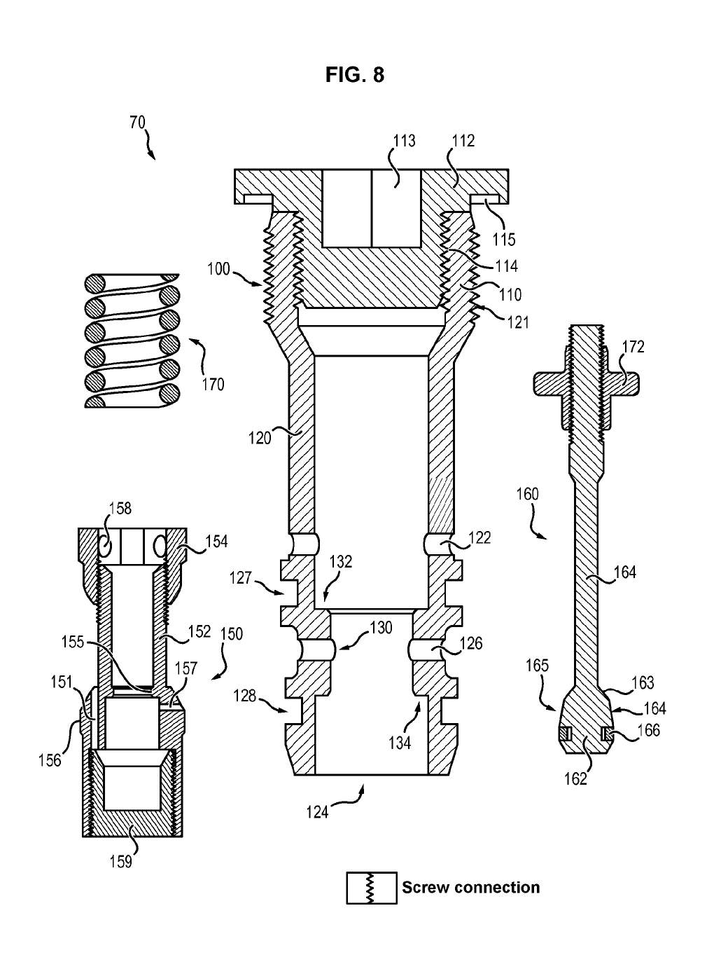

A second variant embodiment of a distributor and pressure relief device conforming to the present invention will now be described with reference to FIGS. 8 to 11.

FIGS. 8 to 11 show a cartridge 100 conforming to the invention integrating a pressure relief device 70 conforming to the invention which integrates means which carry out the function of a pressure selector valve 72 and two pressure limiters grouped in a common assembly 71.

The device 70 comprises a body 110 which has three ports 122, 124, 126: two ports 122, 124 which communicate respectively with the lines 11 and 12, and one port 126 which communicates with the booster line 10.

The booster line 10 may be fed with oil by the booster pump 30 until it attains the boost pressure, which makes the machines M1, M2 operational, or the booster line 10 may be aspirated by the booster pump, which makes the machines M1, M2 non-operational. The machines M1 and M2 are of a type which becomes non-operational, or unclutchable, below a pressure threshold in the lines 11 and 12. The selector connects automatically the lower pressure line to the boost, which allows activation or deactivation of the transmission which is smooth and orderly.

The pressure relief device 100 shown in FIGS. 8 to 11 comprises essentially a body 110 which houses a selector valve 150 and means forming relief valves 160.

The device 100 is centred on a longitudinal axis of symmetry O-O. The device 100 is axially symmetrical overall around the axis O-O.

The body 110 is formed from a cartridge suitable for being integrated in any support structure, for example on the casing of a hydraulic motor.

The body 110 is preferably formed by assembling a casing 120 and a cap 112. The cap 112 may be attached to one axial end of the casing 120 by any appropriate means, for example by crimping or preferably by screwing at complementary threads 114. The cap 112 may be equipped with a non-axially-symmetrical shape 113 allowing it to be clamped, as well as a recess 115 suitable for receiving a seal 116 in contact with the support structure. The axial end of the casing 120 may be equipped on its outer surface with a thread 121 allowing assembly of the device 100 on this support structure.

The casing 120 comprises at least three through passages 122, 124, 126 which correspond to the three aforementioned ports.

One of the through passages 126 is formed in the middle portion of the length of the casing 120. More precisely, several openings 126 equally distributed around the axis O-O are preferably provided.

The passages 122 and 124 are formed respectively on either side of the middle passage 126. More precisely, the passage 122 is preferably formed of several openings 122 equally distributed around the axis O-O.

The passage 124 may also be formed from several openings equally distributed around the axis O-O. However, according to the preferred embodiment, for reasons of manufacture and assembly, the passage 124 is formed from an opening which leads axially on the casing 120 to the opposite end of the cap 112.

The casing 120 preferably comprises on its outer surface two annular recesses 127, 128 disposed between the passages 122, 126 and 124, designed to receive respective seals 103, 105 in contact with the support structure and allowing the hydraulic connections provided toward the passages 122, 126 and 124 to be isolated from one another.

The casing 120 comprises, on its inner surface and at the middle passage 126, a narrowed portion 130 which extends axially on either side of the passage 126. The narrowed portion 130 defines respectively on its two axial ends two seats 132, 134 associated with the selector valve 150.

The narrowed portion 130 which forms the two seats 132, 134 may be integrally formed on the inner surface of the casing 120 or be formed from a separate part applied to the surface of the casing 120 and attached by any appropriate means, for example by screwing, crimping or welding.

The two seats 132, 134 are oriented respectively toward the opposite axial ends of the casing 120.

The selector valve 150 has the general shape of a dual-wheel formed from a central cylinder 152 with a constant rotationally symmetrical cross-section, provided on its two axial ends with respective excrescences 154, 156 protruding on its outer surface.

The protrusions 154, 156 form respectively two annular plugs, directed respectively toward the middle portion of the dual-wheel 150, suitable for cooperating with the seats 132, 134 formed on the casing 120.

The outer diameter of the central cylinder 152 is less than the inner diameter of the narrowed portion 130. The outer diameter of the plugs 154, 156, on the other hand, is greater than the diameter of the seats 132, 134.

Thus, when one of the plugs 154, 156 rests on the associated seat 132, 134, the corresponding valve of the selector valve 150 is closed. Conversely, when a plug 154, 156 is separated from the associated seat 132, 134, the corresponding valve of the selector valve 150 is open.

The use of a selector valve 150 comprising a cage 152 on the ends whereof are formed the respective plugs 154, 156 of two selection valves, makes it possible to guarantee a constant distance between the two plugs 154, 156 and consequently allows guaranteeing that when one of the selection valves is closed, the other selection valve is automatically opened.

The cylinder 152 defines an axial through passage designed to receive a plug 162 slidingly and an associated support stem 164 forming a dual relief valve 160. The cylinder 152 also comprises a plurality of radial through openings 158.

The openings 158 allow free filing of the inner volume of the selector valve 152 and the discharge of the fluid during opening of a relief valve, as will be seen later.

The cylinder 152 and the two excrescences 154, 156 may be formed integrally from a single part. As illustrated in FIGS. 8 to 11, at least one of the excrescences may however be formed from a part applied and attached to the cylinder 152 to facilitate the creation and assembly of the device.

As may be seen in FIGS. 8 to 11, an annular protrusion 155, which serves as a seat for the plug 162, is provided on one end of the cylinder 152 and on the inner surface thereof.

The plug 162 is formed from an excrescence on one end of the stem 164. The plug 162 is placed facing the seat 155, in the volume of the inner chamber of the cylinder 152.

To allow the assembly of the widened plug 162 on the seat 155, the cylinder 152 preferably comprises an end cap 159 screwed to the end of the cylinder 152 after installation of the plug 162.

The stem 164 emerges axially on the end of the selector valve 150 opposite to the plug 162. The stem 164 and its associated plug 162 are biased toward one axial end of the casing 120 by a spring 170.

Thus, the plug 162 is urged to press against the seat 155.

The spring 170 is interposed on the stem 164, between the excrescence 154 and a stop 172 in the form of a ring carried by the stem 164.

Preferably, the stop 172, 192 is adjustable in position over the length of the stem 164 to define the force exerted by the spring 170 and consequently the setting of the opening pressure of the relief valve.

The stop 172 may be attached in position on the stem 164 by any appropriate means, for example by screwing or crimping or welding.

As indicated previously the excrescences 154, 156 and the cylinder 152 are advantageously formed of at least two parts, preferably of three parts, initially separated and assembled by any appropriate means, for example by screwing or crimping or welding, as may be seen in FIGS. 8 to 11. According to FIGS. 8 to 11, the excrescence 154 is formed from an element initially separated from the cylinder 152, but suitable for being applied and attached thereto by any appropriate means, for example by screwing.

Even more precisely, the body of the selector valve 152 comprises radial through passages 157 formed on its axial end outside the seat 155, between the seat 155 and a sealing segment 166 carried by the plug 162.

Moreover, the axial end of the plug 162 directed toward the seat 155 is preferably in the form of a cone frustum 165. More precisely, the frusto-conical surface 165 preferably comprises two axially juxtaposed portions 163 and 164 having different taper ratios.

The portion 163 of this frusto-conical surface 165 rests on the seat 155.

The portion 163 of this frusto-conical surface 165 which is accessible on the inside of the inner chamber of the selector valve 150 is subjected to the pressure coming from the passage 122. It is this portion 163 of the frusto-conical surface 165 which defines the force resulting from the pressure of the passage 122 allowing the force of the spring 170 to be overcome and therefore opening the relief valve in the event of excess pressure in the passage 122.

On the other hand, the portion 164 of the frusto-conical surface 165 which is disposed on the outside of the seat 155 is subjected to the pressure coming from the passage 124 via the aforementioned through passages 157. It is this portion 164 of the frusto-conical surface 165 which defines the force resulting from the pressure of the passage 124 allowing the force of the spring 170 to be overcome, and therefore opening the relief valve in the event of excess pressure in the passage 124.

As may be seen in FIGS. 8 to 11, the taper ratio of the two elementary portions 163 and 164 of the surface 165 may be different to adapt the opening thresholds of the valve under the effect of the pressures respectively of the passage 122 and the passage 124.

Moreover, the widened portion of the plug 162 is guided in translation along the axis O-O of the device in a complementary portion of the body and has here a seal or annular seal segment 166.

The sealing is provided by cooperation between the surface 163 and the seat 155, on the one hand, and between the segment 166 and the complementary cylindrical surface which surrounds it on the other hand. Thus by analogy with FIG. 7, the equivalent of the surface S1 in FIGS. 8 to 11 is delimited by the seat 155 and the equivalent of the surface S2 in FIGS. 8 to 11 is delimited between the seat 155 and the sealing segment 166.

As may be seen on examining FIGS. 8 to 11, as for the appended FIG. 7, the plug 162 has two surfaces situated on either side of the associated seat 155 formed on the cylinder 152 and subjected respectively to the pressures coming from the two feed lines 11 and 12.

Moreover, the device comprises confinement means suitable for applying the pressure of the port 124 to a localized limited zone of the plug 162. More precisely, these confinement means are formed by the seal or annular seal segment 166 and by the channels 157. Thus the pressure that prevails in the feed line associated with port 124 applies only to the face of the plug 162 situated outside the seat 155, more precisely at the surface delimited between the seat 155 and the segment 166.

To allow free displacement of the plug 162 in the housing formed by the cap 159 applied to the end of the cylinder 152, longitudinal channels 151 are preferably provided which form a purge channel and connect this internal housing of the selector valve to the port 126.

The purge channel 151 has a function equivalent to that of the channel 702 in FIG. 7. It allows the movement of the plug 164, and has a damping function if the cross-section of the channel 151 is reduced. However, the channel 151 illustrated in FIGS. 8 to 11 does not lead to the same place as the channel 702 of FIG. 7. In fact, according to FIGS. 8 to 11, the purge channel 151 leads into the booster port 126, while according to FIG. 7 the purge channel 702 leads into the reservoir R.

To assemble the pressure relief device previously described, the procedure is essentially as follows.

First of all, the plug 162 and its stem 164 equipped with the spring 170 and the stop 172, are assembled to the cylinder 152 of the selector valve without the excrescence 154, the plug 162 being place facing the seat 155. The stop 172 is adjusted in position for the desired setting. The closure cap 159 is attached to the body of the selector valve 152.

The subassembly of the relief valve and selector valve thus formed is introduced into the casing 120 through the end thereof opposite to the cap 112. The excrescence 154 is attached to the cylinder 152 of the selector valve.

To this end, the outer surface of the cylinder 152 of the selector valve may be provided with gripping shapes accessible by the passages 126 to facilitate assembly.

Then the cap 112 is attached to the end of the casing 120. The seals are placed in their respective recesses.

The device illustrated in FIGS. 8 to 11, as for FIG. 7, further comprises at least two translation guides for the plug 162, separated, along the longitudinal translation direction O-O thereof, by a distance equal to at least one time the diameter of the plug 162 resting on the associated seat 155, preferably a distance equal to at least two times this diameter and very advantageously, as illustrated in FIGS. 8 to 11, equal to at least five times this diameter.

Even more precisely, as illustrated in FIGS. 8 to 11, the device comprises a first translation guide for the plug 162 formed by the cooperation defined between the tapered end 163 of the plug 162 and its associated seat 155 and at least one second guide formed by the second end of the plug stem 164 guided on the body at the aforementioned collar 172 defining the support of the spring 170. These two guides are separated typically by a distance at least equal to 5 times the diameter of the seat 155.

As may be seen in FIGS. 8 to 11, the device further comprises a third translation guide for the plug formed by the widened portion 162 provided with the seal 166 which move in a channel of complementary diameter formed on the body 152 of the selector.

As indicated previously for the first embodiment of FIG. 7, such multiple guide allows an improvement to the reliability of the device with respect to the dispositions proposed in the prior document US 2005/0097887, without however penalizing the cumulative longitudinal space requirement of the two plugs because, according to the invention, the two relief valves are grouped on common means.

It is understood that the stem 164 associated with the plug 162 works in traction under the biasing of the spring 170.

The operation of the relief device is essentially the following:

At rest, in the absence of pressure on the port 126 and therefore in the booster line 10, and consequently on the ports 122, 124 and therefore in the feed lines 11, 12, the selector valve 150 is capable of free movement in the casing 120 facing the seats 132, 134. The plug 162 biased by the spring 170 rests on the seat 155 and the relief valve is consequently closed.

In operation, during the activation of the booster pump 30 and of a selection of the direction of rotation of the machine M1, one of the ports 122, 124 is subjected to a high pressure while the other portion 124, 122 is subjected to a low return pressure.

The selector valve 150 is thus impinged upon by the high pressure.

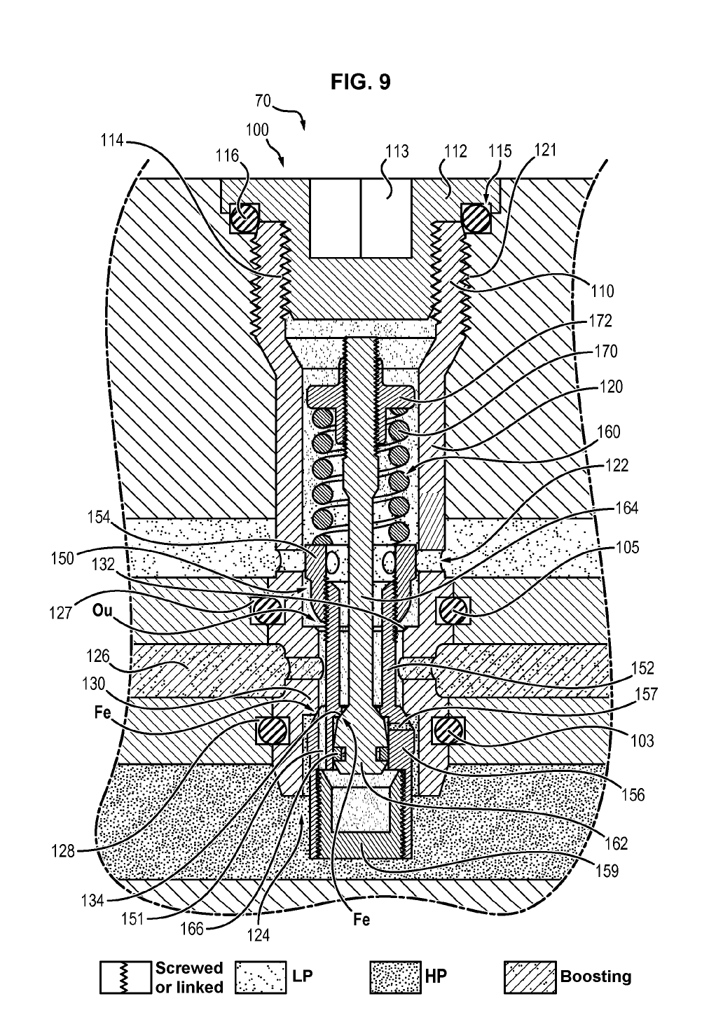

If, as illustrated in FIG. 9, the high pressure is applied to the port 124, the excrescence 156 of the selector valve 150 is urged into contact against the seat 134. The corresponding selection valve is closed. Conversely, a low pressure is applied to port 122. The excrescence 154 of the selector valve 150 is separated from the seat 132. The corresponding selection valve is open.

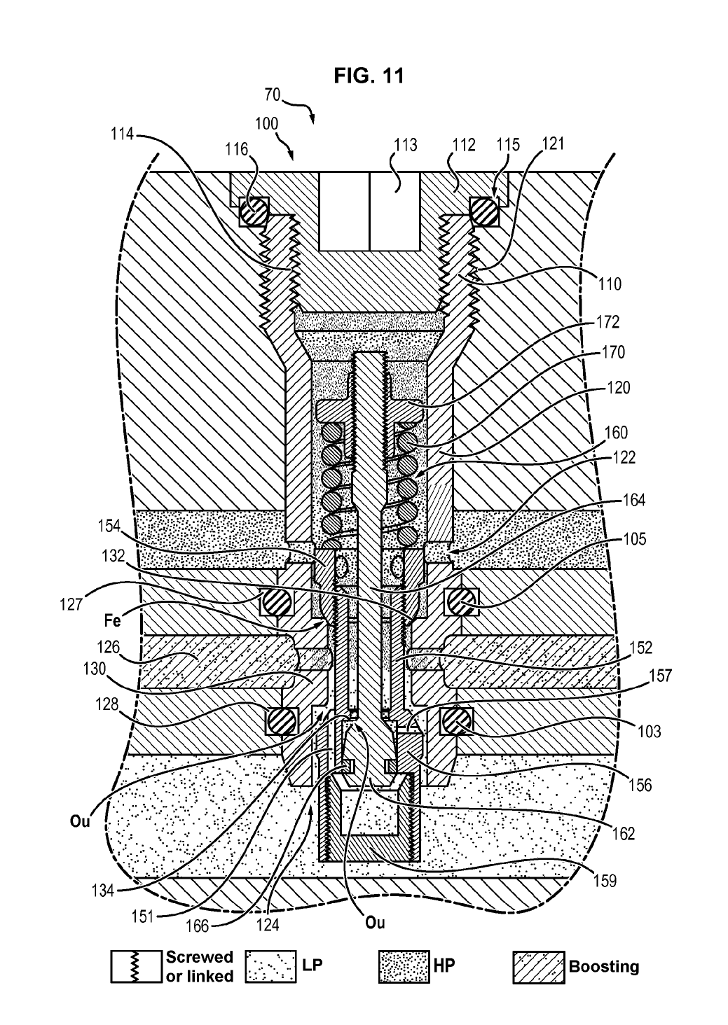

As may be seen in FIG. 11, in case of inversion of the direction of rotation, the high pressure is applied to the port 122. The excrescence 154 of the selector valve 150 is urged into contact against the seat 132. The corresponding selection valve is closed. Conversely, a low pressure is applied to port 124. The excrescence 156 of the selector valve 150 is separated from the seat 134. The corresponding selection valve is open.

The operation of the selector valve is identical during the commissioning or the deactivation of the hydraulic machines, by the use of the booster pump in the sense of causing oil to enter the closed loop or to have oil leave the closed loop.

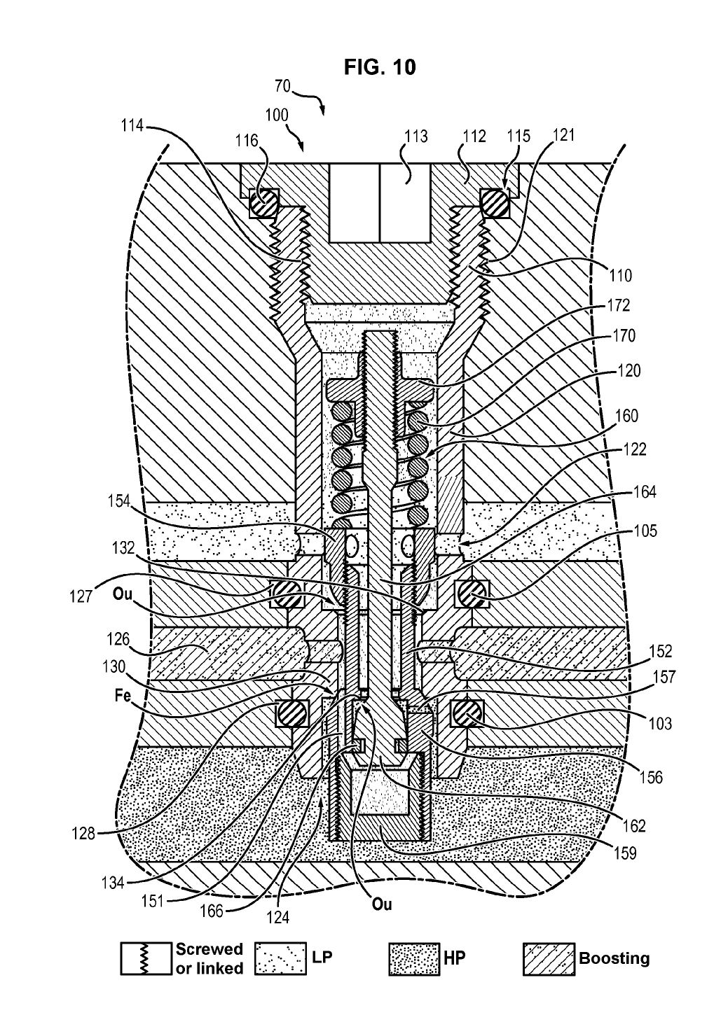

When the pressure in a line 11, 12, exceeds the set threshold of the relief valves defined by the spring 170, this excess pressure applied to the plug 162 ensures the opening of the relief valve, as illustrated in FIGS. 10 and 11 by the separation of the plug 162 with respect to the seat 155. The corresponding excess pressure is then discharged toward the booster line 10 as well as toward the other feed line. The opening of the relief valve shown in FIG. 10 is due to excess pressure coming from the line 124 and applied to the surface 163 situated outside the seat 155 via the passages 157. That shown in FIG. 11 is due to excess pressure coming from the line 122 and applied to the surface 163 situated inside the seat 155.

In FIGS. 9 to 11, the closed valves are designated Fe while the open valves are designated Ou.

A person skilled in the art will understand that the implementation conforming to the invention allows all the functions to be integrated into a component in the form of a cartridge while allowing simple and reliable, as well as independent adjustment of the setting of each relief valve.

The invention may thus be integrated or juxtaposed with one of the machines M1, M2.

Regardless of the embodiment, a device is obtained in which the engagement and disengagement of the machines M1, M2 is controlled only by the booster pump 30 and the reversal of its direction of operation. It is no longer necessary to have recourse to electrically controlled valves.

Regardless of the aspect of the invention, the disengagement of the hydraulic machines M1, M2 is accomplished thanks to circulation, in reverse of boosting operation, of the flow through the pump, typically thanks to the aspiration of the booster pump 30. This circulation may be passive or active. Several types of pumps may be used.

Recall that the preceding figures show a pump 30 driven by an electric motor 31 capable of turning in both directions, but this is in no way limiting.

As a variant, the booster pump may be a variable displacement pump. It is then no longer necessary to have a pressure limiter in parallel with the booster pump. This known type of pump accomplishes a slaving of the displacement of the pump with respect to a set pressure, via a feedback line and a set spring. This type of pump is equivalent to the juxtaposition of a fixed displacement pump and of a pressure limiter.

The booster pump may also be a reverse displacement pump. Such a pump always turns in the same direction, but a change of displacement toward a negative displacement causes aspiration.

The aforementioned reverse displacement pump may be driven by an axle of the vehicle (with a reducer and a coupler, of the disk clutch type, if necessary).

### The Hydraulic Machines M1, M2

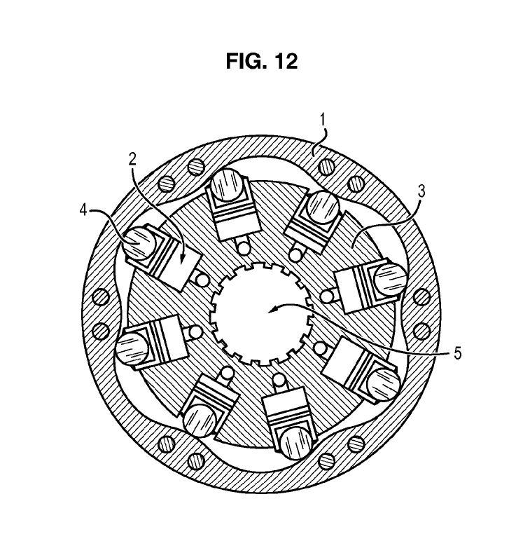

The hydraulic machines M1, M2 are preferably radial piston machines as shown schematically for example in FIG. 12, comprising:
a lobed cam 1,
a plurality of pistons 2 disposed radially in a cylinder block 3, the pistons 2 each comprising a roller 4 capable of rolling on the lobed cam 1,
a shaft 5, which may be secured to the cylinder block when in particular the couplers E1, E2 are engaged.

These machines convert hydraulic energy into mechanical energy due to the variation in displacement of the pistons when they follow the lobed cam.

Such machines M1, M2 have relatively low rotation speeds but have high torque.

Such machines M1 and M2 are preferably placed in a vehicle so as to turn at the speed of the wheels that they must drive, without overdrive or reduction of speed. If there is one machine per axle, this means the average speed of the two wheels of the axle, via a differential or equivalent system.

A casing (not shown) protects the assembly. The casing may serve as a reservoir R. The reservoir R is substantially at atmospheric pressure. It may be connected via breathers, filters or valves, which may create a very slight pressure difference with respect to the outside.

Naturally the present invention is not limited to the embodiments which have just been described, but extends to all variants conforming to its spirit.

According to other advantageous features of the invention:
The hydraulic assistance circuit conforming to the invention comprises: a first hydraulic apparatus and a second hydraulic apparatus, the two motors being connected by a first line and a second line allowing the intake or the discharge of oil into said motors,
a booster pump, disposed between a reservoir and a booster line, the booster line being in communication with at least one of said lines and being able to allow the boosting of said lines by the booster pump, and the pump is configured to be able to aspirate oil into the booster line to allow the decompression of said first and second lines.

Thanks to the activation of the pump in aspiration in the booster circuit, the second transient phase is improved by accelerating the vacuum of the first and second lines. The circulation, in the reverse direction of booster operation, of flow through the pump, may be passive (extinction of the pump and decompression of the lines) or active (control of the pump).

Moreover, the device conforming to the present invention in the form of an autonomous cartridge suitable for being attached, for example by screwing, in a complementary housing formed in a support body, was described previously.

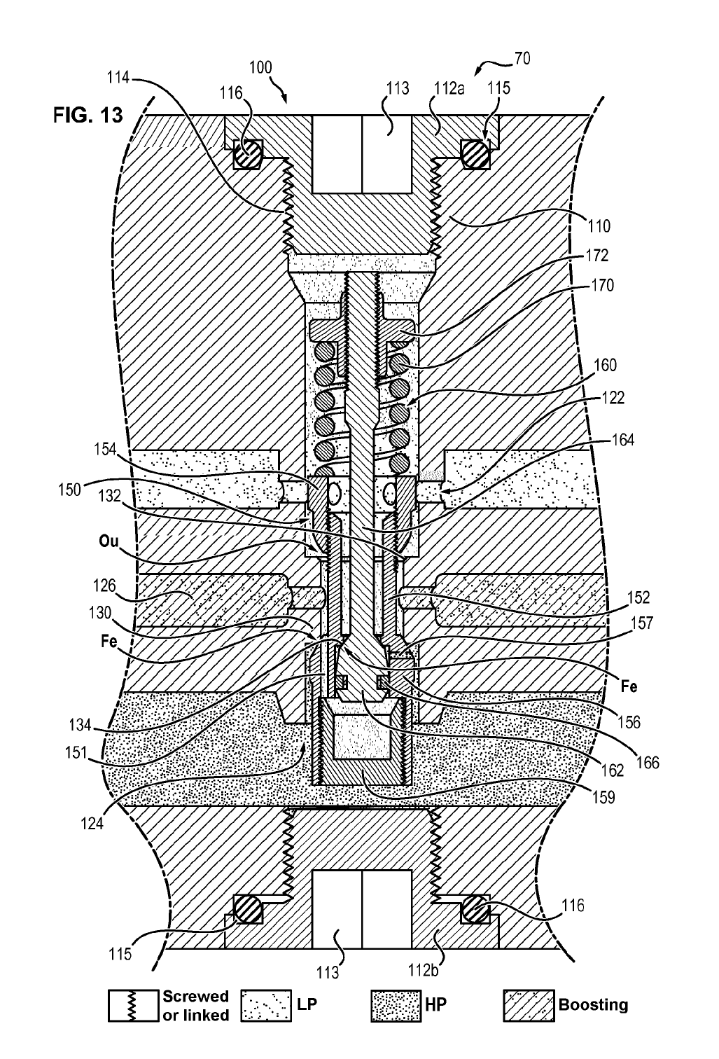

As a variant, as illustrated in FIG. 13 however, it is possible to omit the cartridge body and dispose the elements constituting the selector valve 150 and the relief valves 160 directly in the block of the machined support body, provided that the same shapes and the same function are provided on this support body block. In the case where the support body block thus includes a narrowed portion 130 defining the two seats 132, 134, it is necessary for assembly to provide access from both sides of this narrowed section. It is then necessary to provide two caps for closing these access points as illustrated in FIG. 13 under reference symbols 112a and 112b. Such a disposition facilitates installation and adjustment.

The closure of the housing which receives the selector valve 72, 150 and the pressure relief valve 71, 160 with a removable cap 112 allows simple adjustment of the threshold pressure for opening the relief valves. It is in fact sufficient to withdraw the cap 112 to gain access to the adjustment elements of the spring(s) 70, adjust them, then replace the cap 112.

1. A distributor and pressure relief device suitable to be installed in a system comprising a first feed line and a second feed line which may comprise pressurized oil and comprising a discharge and/or booster line, characterized in that the device comprises means forming a pressure selector valve suitable for connecting the lower pressure feed line to the discharge and/or booster line and means forming two valves associated respectively with one of the two feed lines and suitable for opening in the event of excess pressure above a predetermined threshold in the associated feed line so as to discharge the corresponding excess pressure toward the discharge and/or booster line or the other feed line, the two valves comprising a common plug which cooperates with a single seat.

2. The device according to claim 1, wherein the two pressure relief valves comprising a common plug which cooperates with a single seat comprise a common support stem which works in tension or in compression under the biasing of at least one spring defining a setting which corresponds to said predetermined threshold.

3. The device according to claim 1, wherein the plug has at least two surfaces (Si, S2) situated on either side of the associated seat and subjected respectively to the pressures coming from the two feed lines.

4. The device according to claim 3, wherein it comprises confinement means suitable for applying pressure coming from a feed line to a limited localized zone of the plug.

5. The device according to claim 1, wherein it comprises two translation guides for the plug, separated along the longitudinal direction of translation thereof, by a distance equal to at least one times the diameter of the plug resting on the associated seat, preferably by a distance equal to at least two times this diameter and very advantageously equal to at least five times this diameter.

6. The device according to claim 5, wherein it comprises a first translation guide for the plug formed by the cooperation defined between the plug and its associated seat and at least a second guide formed by an end of a plug stem guided on the body, for example a widened surface subjected to the pressure of a feed line or a support means for a biasing spring.

7. The device according to claim 1, wherein the pressure selector valve between the first and second lines is suitable for selecting the lower pressure line among the first and second lines (11, 12), so that the oil may circulate in the reverse direction of operation during boosting and decompress itself in the reservoir through the booster line and the booster pump, advantageously aspired in the lower pressure line and discharged to the reservoir (R) thanks to said pump.

8. The device according to claim 7, wherein pressure limiters are disposed in parallel with the selector valve between the booster line and the first and second lines, so as to protect the latter two from excess pressure.

9. The device according to claim 7, wherein the low pressure selector valve is an inverse shuttle valve always leaving the line with the lower pressure among the first and second lines in communication with the booster line.

10. The device according to claim 9, wherein the pressure selector valve comprises two check valves back to back, each comprising a sealing element and a seat, the sealing elements being separated from one another by a means preventing the two selector valves from closing at the same time.

11. The device according to claim 1, wherein the pressure selector valve and the pressure limiters are formed by a single valve, said valve comprising a cartridge in which a tappet and a pin may slide in relative position along the longitudinal axis (X-X′) of the valve, wherein:
the tappet separates the cartridge into a first volume (V1) fed by the first line and into a second volume (V2) fed by the second line, the two volumes (V1, V2) being able to communicate with one another through an inner channel comprised in the tappet,
the tappet defines an annular volume (Va) with the cartridge, the annular volume (Va) communicating alternately with the first or the second volume (V1, V2) depending on the position in translation of the tappet in the cartridge along the longitudinal axis (X-X′),
the pin comprises a first end suitable for blocking said channel in a rest position, and a second end in contact with a spring which holds the pin in the rest position, the pin being movable in translation along the longitudinal axis (X-X′) to open or block the inner channel,
so that when the channel is blocked, the position of the tappet is a function of the forces originating in the pressures of the first volume (V1) and of the second volume (V2) exerted on either side of the tappet, and the booster line is thus placed in communication with the line which has the lower pressure among the first and second lines,
the pin comprises a first surface (Si) leading into the first volume (V1) on which is exerted a force originating from the pressure of the first volume (V1), and a second surface (S2) leading into the second volume (V2) on which is exerted a force originating from the pressure of the second volume (V2), the two forces both opposing the force of the spring,
so that, when the two forces are greater than that of the spring, the pin undergoes translation and opens said channel, thus placing in communication the high and low pressure lines.

12. The device according to claim 1, wherein it comprises a single setting spring.

13. The device according to claim 1, wherein the pressure selector valve is in the form of a cage defining two seats, characterized in that the device further comprises at least one adjustment means of the means forming a relief valve, disposed on the outside of an axial end of the pressure selector valve in the form of a cage to allow adjustment of the setting of the associated relief valve.

14. The device according to claim 1, wherein the means forming two relief valves comprise a single plug formed from an excrescence on one end of a stem, the stem emerging axially on one end of the selector valve and the stem and its associated plug being biased toward an axial end of the device by a spring interposed on the stem between an excrescence forming the plug and a stop carried by the stem.

15. The device according to claim 14, wherein the stop is adjustable in position over the length of the associated stem to define the force exerted by the spring and consequently the setting of the opening pressure of the means forming a relief valve.

16. The device according to claim 14, wherein the stop is fixed in position on the stem, for example by screwing, crimping or welding.

17. The device according to claim 1, wherein the selector valve comprises a dual-wheel formed from a central cylinder provided on its two axial ends with respective excrescences protruding on its outer surface and on its inner surface, with a protrusion defining a relief valve seat, the cylinder and the excrescences being formed of at least two parts initially separated and assembled together.

18. The device according to claim 17, wherein the central cylinder of the selector valve comprises at least one radial through passage.

19. The device according to claim 1, wherein it comprises a body including a casing which has a narrowed portion forming two selector valve seats on either side of a passage designed to be connected to the discharge and/or booster line, which narrowed portion is preferably integrally formed with the inner surface of the casing.

20. The device according to claim 1, wherein the body of the selector valve comprises radial through passages formed on one axial end outside of the pressure relief valve seat.

21. The device according to claim 1, wherein the axial end of the plug directed toward the associated seat is in the form of a cone frustum.

22. The device according to claim 21, wherein the frusto-conical surface rests on the seat.

23. The device according to claim 21, wherein a portion of the frusto-conical surface which is accessible on the inside of the inner chamber of the selector valve is subjected to the pressure coming from a first passage, while the portion of the frusto-conical surface which is disposed on the outside of the seat is subjected to the pressure coming from a second passage via passages passing through the body of the selector valve.

24. The device according to claim 21, wherein the taper ratio of the two elementary portions of the tapered surface are different to adapt the opening thresholds of the valve under the effect of the pressures respectively of the two passages.

25. The device according to claim 1, wherein it comprises means forming a damper for the movement of the common plug.

26. The device according to claim 25, wherein the means forming a damper for the movement of the common plug comprise a calibrated oil leakage channel.

27. The device according to claim 1, wherein the means forming a selector valve and the relief valves are placed in a housing closed by a removable cap the withdrawal whereof allows adjustment of the setting of the spring.

28. The device according to claim 1, wherein the elements constituting the selector valve and the relief valves are placed in the block of a machined support body and provided with two closure caps.

29. A hydraulic assistance system wherein it comprises a distributor and relief device conforming to claim 1.

30. An assistance system for a vehicle according to claim 29, wherein it comprises:
a first hydraulic apparatus (M1) and a second hydraulic apparatus (M2), the two apparatuses (M1, M2) being connected by a first line (11) and a second line allowing the intake or the discharge of oil into said motors (M1, M2),
a booster pump, disposed between a reservoir (R) and a booster line, the booster line being in communication with at least one of said lines and being able to allow the boosting of said lines by the booster pump,
wherein the pump is configured to be able to aspirate oil into the booster line (10) to allow the decompression of said first and second lines.

31. A vehicle equipped with a pressure relief device according to claim 1.

32. A vehicle equipped with a hydraulic assistance system according to claim 29.

33. A vehicle equipped with a hydraulic assistance system according to claim 30.
